(19) United States
(12) Patent Application Publication
(10) Pub. No.: US 2006/0158431 A1
(43) Pub. Date: Jul. 20, 2006

(54) Pointing device with multidirectional window viewing function

(76) Inventors: Ming-Hsun Tsai, Taipei (TW); Chih-Wen Su, Taipei (TW)

Correspondence Address: Han-Yi Lee;BAYSHORE PATENT GROUP, LLC., 520 Chantecler Dr., Fremont, CA, 94539, US

(21) Appl. No.: 11/201,049

(22) Filed: Aug. 10, 2005

(30) Foreign Application Priority Data
Jan. 20, 2005 (TW) 094101639

(51) Int. Cl. G09G 5/08

(52) U.S. Cl. 345/163

(57) ABSTRACT

The present invention relates to a pointing device with multidirectional window viewing function. The pointing device with multidirectional window viewing function comprises a multidirectional roller, which moves in at least three directions and triggers actuating signals corresponding to each direction, including an oblique direction; and a controller, which receives the actuating signal and produces its corresponding source packet, which is received by a receiving terminal. By manipulating the multidirectional roller, a user is able to view and move the text in the window in multiple directions corresponding to the movement of the roller.

### BACKGROUND OF THE INVENTION

1. Field of the Invention

The present invention relates to a pointing device, particularly to a pointing device with multidirectional window viewing function.

2. General Background and State of the Art

In almost any known mouse, there is a roller in between the right and the left buttons. The most significant function of the roller is to enable a user to view up and down a webpage or a written page without the hassle of pointing to the scroll on the side. However, current known roller can only scroll up or down a page. When a user needs to move a window frame to its right or left, he has to first move a known pointing device, place a cursor over the bottom scroll, and then make right or left movement. Known pointing devices, therefore, have defects in their limited degree of manipulation.

The present invention overcomes the above limitation of the related arts. It is an object of the present invention to provide a pointing device with a multidirectional roller, which moves in at least three directions, including an oblique direction, and enables one to view window content with a simple control.

### SUMMARY

The first objective of the present invention is to provide a pointing device with multidirectional window viewing function which enhances interface serviceability for viewing windows by way of moving the roller in multiple directions, including an oblique direction.

To achieve the purpose of this present invention, the present invention provides a pointing device with multidirectional window viewing function which comprises a multidirectional roller, which moves in at least three directions, including an oblique direction, and triggers actuating signals corresponding to each direction; and a controller, which receives said actuating signal and produces its corresponding source packet, which is received by a receiving terminal. By manipulating the multidirectional roller, a user is able to view and move the text in the window in multiple directions corresponding to the movement of the roller.

### BRIEF DESCRIPTION OF THE DRAWINGS

Aspects of the present invention are illustrated by way of example, and not by way of limitation, in the accompanying drawings, wherein:

FIG. 1 illustrates a three-dimensional perspective view of the pointing device with multidirectional window viewing function of the present invention;

FIG. 2 shows a cross-sectional view of the pointing device in FIG. 1; and

FIG. 3 is a schematic view showing the pointing device of the present invention in one operational state.

### DETAILED DESCRIPTION OF THE PREFERRED EMBODIMENT

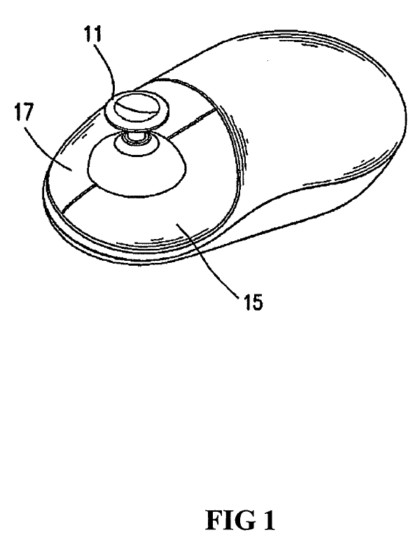

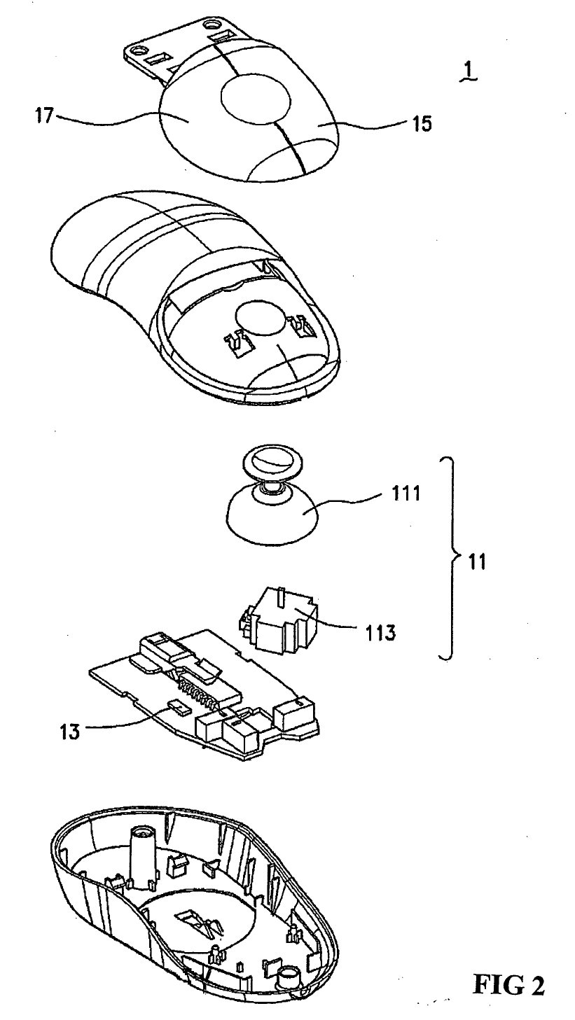

FIG. 1 illustrates a three-dimensional perspective view of the pointing device with multidirectional window viewing function of the present invention. FIG. 2 shows a cross-sectional view of the pointing device in FIG. 1 The pointing device 1 of the present invention is characterized by its multidirectional roller 11, which moves in at least three directions and triggers corresponding actuating signals for each direction. At least one actuating signal is triggered by a movement in oblique direction. A controller receives the above actuating signal and produces corresponding source packet to be received by a receiving terminal. The multidirectional roller has the same setup as that of known arts—the multidirectional roller 11 is situated in between the left 15 and the right 17 buttons.

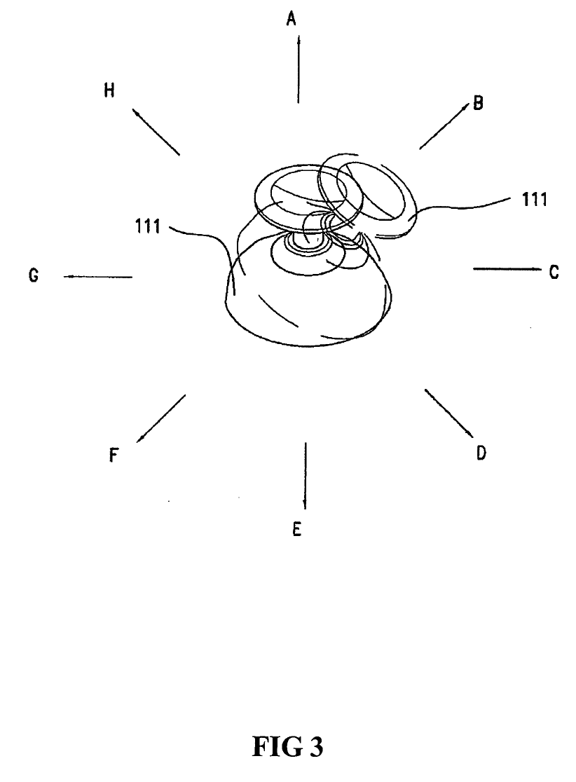

One embodiment of the multidirectional roller 11, as shown in FIG. 1 and FIG. 2, is a joystick, used in its usual way. As shown in FIG. 2 and FIG. 3, the joystick 11 comprises the stick 111 and the switch 113. The stick is able to be moved in at least eight directions 111: including up A, down B, left G, right C, upper left H, upper right B, lower left F and lower right D, followed by an actuating signal produced by the switch 113 and corresponding to one of the above direction. The controller 13, after receiving the actuating signal, would produces source packet corresponding to the actuating signal. In this way a user can view and move the text in the window by an simple control of the joystick 1.

The pattern of source packets corresponding to actuating signals of the present invention is set to be the same as that of others in the art in order to fulfill the requirement of compatibility. One embodiment of source packets corresponding to actuating signals of the present invention is shown in Table I below:

TABLE I

| | bit | bit 7 | bit 6 | bit 5 | bit 4 | bit 3 | bit 2 | bit 1 | bit 0 |
|---|---|---|---|---|---|---|---|---|---|
| First Bite | meaning | Y | X overflow | plus or | plus or | unused | middle | right button | left button |
| | | overflow | | minus Y | minus X | | button | | |
| Second | meaning | plus or | X | X | X | X | X | X | X |
| Bite | | minus X | displacement | displacement | displacement | displacement | displacement | displacement | displacement |
| | | | value | value | value | value | value | value | value |
| Third | meaning | plus or | Y | Y | Y | Y | Y | Y | Y |
| Bites | | minus Y | displacement | displacement | displacement | displacement | displacement | displacement | displacement |
| | | | value | value | value | value | value | value | value |
| Fourth | meaning | P5 | P4 | P3 | P2 | P1 | P0 | Z | Z |
| Bite | | | | | | | | displacement | displacement |
| | | | | | | | | value | value |

The meaning of Bit 2 [P0] through Bit 7 [P5] is shown in Table II below:

TABLE II

| P5˜P0 | P5 | P4 | P3 | P2 | P1 | P0 | Meaning |
|---|---|---|---|---|---|---|---|
| Data | 0 | 0 | 0 | 0 | 0 | 0 | Up |
| Format | 0 | 0 | 0 | 0 | 0 | 1 | Upper Left |
| | 0 | 0 | 0 | 0 | 1 | 0 | Upper right |
| | 0 | 0 | 0 | 0 | 1 | 1 | Left |
| | 1 | 1 | 1 | 1 | 1 | 0 | Lower left |
| | 1 | 1 | 1 | 1 | 0 | 1 | Lower right |
| | 1 | 1 | 1 | 1 | 0 | 0 | Right |
| | 1 | 1 | 1 | 1 | 1 | 1 | Down |

According to Table I, the First through the Third bites adopt the data format existing in the printing device 1. The Fourth bite are actuating signals and adopts the data format of those used by the First bite through the Third bite. Therefore, the pointing device of the present invention possess the advantage of compatibility.

The multidirectional roller 11 is not limited to be a joystick and could be replaced with other components, for example, a component with multidirectional buttons. Various modifications to this embodiments will be readily apparent to those skilled in the art, and the generic principles defined herein may be applied to other embodiments without departing from the spirit or scope of the invention.

One embodiment of the receiving terminal of the present invention is a computer, which receives source packets sent by the receiving controller 13 via a PS/2 connector. Furthermore, another embodiment of the receiving terminal is a receiver which electrically connects to a computer, receives source packets sent by receiving controller 13, and relay the packets to the computer.

The pointing device 1 could be a wired pointing device, a wireless pointing device, a roller pointing device, an optical pointing device, a laser optical pointing device, an infrared optical pointing device and others.

The multidirectional roller of the present invention possesses structural characteristics enhance convenience in window viewing control and surpasses any known pointing devices.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A pointing device with multidirectional window viewing function, comprises:
a multidirectional roller, which moves in at least three directions, including an oblique direction, and triggers actuating signals corresponding to each direction;
a controller, which receives said actuating signal and produces its corresponding source packet, which is received by a receiving terminal.
By manipulating said multidirectional roller, a user is able to view and move the text in the window in multiple directions corresponding to the movement of said roller.

2. The pointing device as in claim 1, wherein said receiving terminal is a computer.

3. The pointing device as in claim 1, wherein said receiving terminal is a receiver compatible to said pointing device and electrically connects to said computer.

4. The pointing device as in claim 1, wherein said pointing device is a wired pointing device, a wireless pointing device, a roller pointing device, an optical pointing device, a laser optical pointing device, or an infrared optical pointing device.

5. The pointing device as in claim 1, wherein said pointing device is a wired pointing mouse, a wireless mouse, a roller mouse, an optical mouse, a laser optical mouse, an infrared optical mouse.

6. The pointing device as in claim 1, wherein said multidirectional roller is a joystick.

7. The pointing device as in claim 1, wherein multidirectional roller is a multidirectional switch.

8. The pointing device as in claim 1, wherein said multidirectional roller is situated in between the left button and the right button of said pointing device.

9. The pointing device as in claim 1, wherein the packet pattern of said source is compatible packet pattern and maintains its consistency with other packet patterns.
